(19) United States
(12) Patent Application Publication
(10) Pub. No.: US 2006/0244238 A1
(43) Pub. Date: Nov. 2, 2006

(54) Wheelchair tray

(76) Inventor: Connie Lewis, Greenup, IL (US)

Correspondence Address: Michael Berns;Maloney Parkinson & Berns, 135 West Main Street, Urbana, IL, 61801, US

(21) Appl. No.: 11/119,105

(22) Filed: May 2, 2005

(51) Int. Cl. A61G 5/10

(52) U.S. Cl. 280/304.1

(57) ABSTRACT

A wheelchair tray for mounting to a wheelchair, which is capable of extending laterally to provide a tray with a larger surface area. This allows the wheelchair user to have a larger storage capacity for the tray, yet collapse into a smaller position, such that the wheelchair is not difficult to move or maneuver through narrow spaces.

### BACKGROUND OF THE INVENTION

People who use wheelchairs often require a flat, stable surface for objects. The trays available often attach to the wheelchair handles and extend across the user's lap. This is helpful in holding books, food, communication devices, or other objects.

There have been many patents on wheelchair trays and folding trays. U.S. Pat. No. 3,338,627 discloses a simple tray for extending across the wheelchair handles. U.S. Pat. No. 4,054,315 shows an easel that is adapted to a wheelchair tray. U.S. Pat. No. 6,685,264 describes an articulating tray that may be positioned according to the wheelchair user's needs.

Wheelchair users often have a need for additional tray space. This has been provided by larger wheelchair tables, but there is a need for a product that can operate in a smaller position for travel and then extend into a larger tray, as the user needs additional space. Larger trays would make the wheelchair difficult to navigate hallways, doors, or other tight areas.

### SUMMARY OF THE INVENTION

The present invention provides a wheelchair tray that has a collapsed position to make the wheelchair easy to move and maneuver, and an extended position, whereby the surface area of the tray is expanded to provide more work or storage space.

### DESCRIPTION OF THE DRAWINGS

FIG. 1 is an isometric view of a wheelchair provided with a tray according to one embodiment of the invention in a table position.

FIG. 2 is an isometric view of a wheelchair provided with a tray according to one embodiment of the invention in a collapsed position.

FIG. 3 is a bottom view of an alternate embodiment of the invention having a recessed user area.

### DETAILED DESCRIPTION OF THE INVENTION

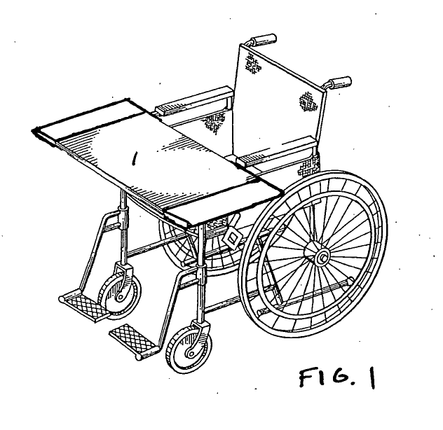

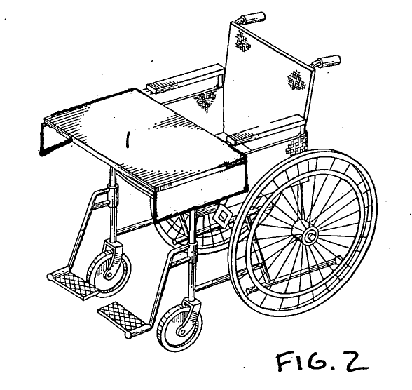

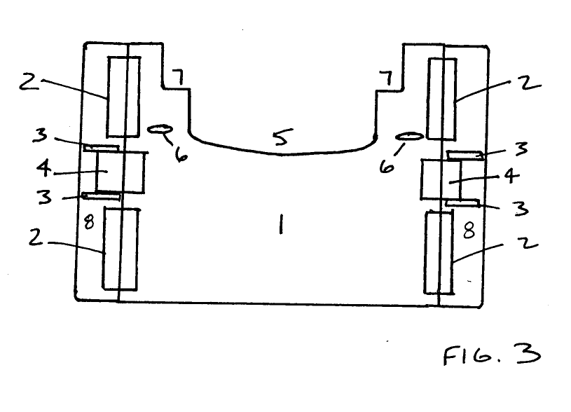

As shown in the figures, the present invention provides for a wheelchair tray having an extendable tray. FIG. 1 and FIG. 2 show a rectangular embodiment of the tray. FIG. 3 shows an embodiment of the tray that fits around the user's body, providing more work or storage space, and reducing the distance between the tray and the user. Wheelchair trays using this design are common, especially for user's having more severe disabilities.

In FIG. 3, a preferred embodiment is shown having a simple design. Four hinges 2 are attached to a main tray body 1 and wings 8. The hinges 2 allow the wings 8 to extend to a table position, such that the upper surface of the wings 8 is relatively flush with the upper surface of the main tray body 1, such that in combination, a larger tray is produced. The hinges 2 may also rotate the wings 8 into a collapsed position. The collapsed position as shown in FIG. 2, allows the wings 8 to fold downwardly to store the wings 8 vertically along the side of the wheelchair. In the collapsed position, the width of the wheelchair is ideally no wider than the wheelchair width without a tray. This allows maximum accessibility for the wheelchair to move through narrow spaces, such as hallways, doors, or other restrictions.

To hold the wings 8 in the table position, a preferred method has been found to be inexpensive, lightweight and effective. Two rails 3 are attached to each wing 8. A block 4 is slidingly connected to the rails 3, such that when the block 4 is pushed completely between the rails 3, the hinges 2 on that wing 8 may rotate. When the wing 8 is extended to the table position, the block 4 may be pushed along the rails 3 to a stop point such that the outer edge of the block 4 does not go past the inner edge of the rails 3. In this position, the block 4 provides a support, locking the wings 8 into the table position.

An alternate embodiments for the support may include an embodiment wherein the wings 8 fold upwardly to a collapsed position, such that the wings 8 would rest on the upper surface of the main tray 1. If the wings 8 were approximately one half the size of the main tray 1, the wings 8 would provide a flat surface above the main tray 1.

Another embodiment would provide a telescoping wing 8, such that in a collapsed position, the wings 8 would be held inside the main tray 1. The wings 8 would extend outwardly from the main tray into the table position. This may provide a small drop between the main tray 1 and the wings 8 that the user may dislike.

The preferred embodiment is produced in wood, which has been found to be inexpensive, lightweight, and workable. Other models could be produced in plastic or other materials.

Attachment to the wheelchair may be provided by straps connected to the tray. FIG. 3 shows slots 6 that allow for attachment of the tray 1 to the wheelchair. Other methods of attaching wheelchair trays are commonly known.

What is claimed is:

1. A tray for attachment to a wheelchair, comprising:
a planar tray surface located within the width of the wheelchair,
at least one extension tray wing generally extending the tray surface laterally beyond the width of the wheelchair,
means for collapsing said at least one extension tray wing to a collapsed position within the width of the wheelchair, and
means for attaching the tray to a wheelchair.

2. The wheelchair tray according to claim 1, wherein said planar tray surface provides a recessed area to wrap around the torso of a wheelchair user.

3. The wheelchair according to claim 1, wherein said at least one extension tray wing are hingedly attached to the planar tray surface, such that the at least one extension tray wing and the planar tray surface may form a larger tray surface.

4. The wheelchair tray according to claim 1, wherein said at least one extension tray wing are telescopically attached to the planar tray surface, such that the at least on extension tray wing and the planar tray surface may form a larger tray surface.

5. The wheelchair according to claim 3, wherein the at least one extension tray wing may be folded downwardly to a generally vertical position along the sides of the wheelchair.

6. The wheelchair according to claim 1, wherein the at least one extension tray wing further comprise a first extension tray wing on one side of the planar tray surface, and a second extension tray wing on the opposite side of the planar tray surface.

7. The wheelchair according to claim 1, wherein the at least one extension tray wing extends off of the wheelchair.
